(19) United States
(12) Patent Application Publication
(10) Pub. No.: US 2026/0308711 A1
(43) Pub. Date: Oct. 8, 2026

(54) SYSTEMS AND METHODS FOR IMPROVED METAL RECOVERY BY LEACHING

(71) Applicant: FREEPORT MINERALS CORPORATION, Phoenix, AZ (US)

(72) Inventor: Sarah Lyons, Vail, AZ (US)

(73) Assignee: FREEPORT MINERALS CORPORATION, Phoenix, AZ (US)

(21) Appl. No.: 19/171,108

(22) Filed: Apr. 4, 2025

(51) Int. Cl. C22B 3/20; C01G 49/02; C22B 1/16; C22B 3/44; C22B 15/00

(52) U.S. Cl. CPC C22B 3/205; C01G 49/02; C22B 1/16; C22B 3/44; C22B 15/0006; C22B 15/0065; C22B 15/0089

(57) ABSTRACT

A method for improving recovery of a metal value from a metal-bearing material is provided. The method includes applying a leaching solution to the metal-bearing material to form a pregnant leach solution, wherein the leaching solution comprises a chelating surfactant, wherein the chelating surfactant is comprised of citric acid or salts thereof and decreases a contact angle between the leaching solution and the metal-bearing material. The method further includes recovering the metal value from the pregnant leach solution to form a raffinate, wherein the metal-bearing material comprises pyrite, and wherein the leaching solution comprises a concentration of citric acid in a range on the order of about 0.1 g/L to about 3 g/L.

### FIELD OF INVENTION

The present disclosure generally relates to recovering metal values from metal-bearing materials, and specifically to leaching methods and systems comprising pyrite and citric acid or citrates.

### BACKGROUND

Advances in leaching technology have made it possible to recover copper values from copper sulfides, such as, for example, chalcopyrite, chalcocite and covellite. Copper sulfides are generally more expensive to leach using traditional leaching practices, as their refractory nature makes it more difficult to break the mineral matrix and free the copper value. Thus, alternative leaching practices are required, and many have been proposed, such as, for example, the use of covers to retain heat and/or additives that that may directly or indirectly improve leaching conditions.

One such proposed practice is outlined in U.S. Pat. No. 11,236,407, wherein high concentrations of pyrite are mixed with a refractory ore and then leached with sulfuric acid. This patent discloses that the use of pyrite generates acid and heat, encouraging leaching conditions beneficial to promote improved copper sulfide leaching and ultimate copper recovery.

While high temperatures are known to improve copper sulfide leaching, particularly chalcopyrite leaching, the oxidation process of pyrite produces substantial amounts of iron, which, if not controlled, will precipitate out into iron hydroxide, passivating the chalcopyrite and ultimately inhibiting further leaching. Thus, improvements to current technologies are needed to render them feasible in practice, with a particular need for leaching methods that mitigate iron precipitation.

The present disclosure addresses the long felt need of improved iron control in copper sulfide leaching with the use of citric acid. In the paper Influence of Chelating Reagents on Leaching of Copper Ore by Larry Haas and Terry Hebble (“Haas”), it was demonstrated that the use of citric acid may improve the permeability of ore and finds use as an effective chelating agent. However, Haas does not provide a comprehensive review or suggest other benefits of citric acid. While stating that citric acid may be used in leaching processes to improve permeability, the teachings from Haas are limited. Therefore, improvements to the process disclosed in Haas are needed to produce a workable procedure for efficiently implementing citric acid in a leaching process. The present disclosure builds on Haas's process through extensive research and testing to identify previously unknown benefits of citric acid and improve metal recovery rates.

### SUMMARY

In general, the present disclosure relates to methods and systems for recovering metal values from metal-bearing materials and, more specifically, to leaching methods and systems using citric acid or salts thereof to leach a sulfide ore. Various embodiments of the present invention provide a method for recovering a metal value from a metal-bearing material comprise applying a leaching solution to the metal-bearing material to form a pregnant leach solution, wherein the leaching solution comprises a chelating surfactant, wherein the chelating surfactant is comprised of citric acid or salts thereof and decreases a contact angle between the leaching solution and the metal-bearing material, and recovering the metal value from the pregnant leach solution to form a raffinate, wherein the metal-bearing material comprises pyrite, and wherein the leaching solution comprises a concentration of citric acid in a range on the order of about 0.1 g/L to about 3 g/L.

In various embodiments, the method may further comprise precipitating, via a precipitation process, iron hydroxide out of the metal-bearing material, and removing, via a removal process, the iron hydroxide from the metal-bearing material, wherein the removing renders the metal-bearing material amenable to an additional leaching process. In various embodiments, the method may further comprise adding a supplementary addition of pyrite to the metal-bearing material.

In various embodiments, the method may further comprise agglomerating the metal-bearing material with an agglomeration solution before the step of applying the leaching solution, wherein the agglomeration solution comprises the raffinate and optionally citric acid or salts thereof. In various embodiments, the leaching solution comprises a concentration of citric acid or salts thereof in the range on the order of about 0.6 g/L to about 1.8 g/L. In various embodiments, the leaching solution comprises a concentration of citric acid or salts thereof on the order of about 0.3 g/L.

In various embodiments, the method may further comprise exposing the leaching solution to a source of UV light before the step of applying it to the metal-bearing material. In various embodiments, the source of UV light may comprise at least one of artificial light or the sun.

In various embodiments, the method may further comprise forming at least a portion of a heap with the metal-bearing material before the step of applying the leaching solution to the metal-bearing material. In various embodiments, the raffinate is recycled in the method, and wherein the leaching solution comprises the raffinate, and wherein the raffinate comprises a retained concentration of the citric acid or salts thereof.

Other embodiments of the present invention provide a method of recovering copper from a metal-bearing material. In various embodiments, the method may comprise obtaining the metal-bearing material from a mine, combining the metal-bearing material with pyrite to form a combined metal-bearing material, heap leaching the combined metal-bearing material with a leaching solution comprising a chelating surfactant, wherein the chelating surfactant comprises citric acid or salts thereof, with pyrite generating acid, heat, and iron that facilitate recovering copper from the metal-bearing material, and with citric acid converting ferric iron into ferrous iron to prevent iron hydroxide precipitation, and forming a pregnant leach solution, and recovering copper from the pregnant leach solution. In various embodiments, the metal-bearing material comprises an inherent concentration of pyrite.

Other embodiments of the present invention provide a method of treating a leaching stockpile. In various embodiments, the method may comprise identifying, via a permeability test, at least one area of passivated metal-bearing material within the leaching stockpile, treating the at least one area of passivated metal-bearing material with a treatment solution comprising citric acid or salts thereof, wherein the treatment solution dissolves a precipitated material into the treatment solution to form a pregnant leach solution, and recovering a metal value from the pregnant leach solution.

In various embodiments, the precipitated material is an iron hydroxide. In various embodiments, the metal-bearing material comprises pyrite. In various embodiments, the metal value is copper.

### BRIEF DESCRIPTION OF THE DRAWINGS

The subject matter is pointed out with particularity and claimed distinctly in the concluding portion of the specification. A more complete understanding, however, may best be obtained by referring to the detailed description and claims when considered in connection with the following drawing figures.

FIG. 1 is an exemplary Pourbaix diagram for iron at ambient temperatures.

FIG. 2 is a graph showing the impact of citric acid on pH of various leaching systems in accordance with various embodiments of the present invention.

FIG. 3 is a graph showing the impact of citric acid on contact angle of various ore samples in accordance with various embodiments of the present invention.

FIG. 4 is a graph showing the impact of citric acid on copper recovery of various ore samples in accordance with various embodiments of the present invention.

FIG. 5 is a graph showing the impact on pyrite addition on copper recovery of various leaching systems in accordance with various embodiments of the present invention.

FIG. 6 is a graph showing the impact of the combination of citric acid and pyrite addition on copper recovery of various leaching systems in accordance with various embodiments of the present invention.

FIG. 7A is a resistivity scan of a leach stockpile before treatment in accordance with various embodiments of the present invention.

FIG. 7B is a resistivity scan of a leach stockpile during treatment in accordance with various embodiments of the present invention.

FIG. 7C is a resistivity scan of a leach stockpile after treatment in accordance with various embodiments of the present invention.

FIG. 7D is a legend for use with the resistivity scans of FIGS. 7A-7C.

### DETAILED DESCRIPTION OF EXEMPLARY EMBODIMENTS

The following description is merely exemplary in nature and is not intended to limit the present invention, its applications, or its uses. It should be understood that throughout the drawings, corresponding reference numerals indicate like or corresponding parts and features. The description of specific examples indicated in various embodiments of the present invention are intended for purposes of illustration only and are not intended to limit the scope of the invention disclosed herein. Moreover, recitation of multiple embodiments having stated features is not intended to exclude other embodiments having additional features or other embodiments incorporating different combinations of the stated features.

Furthermore, the detailed description of various embodiments herein makes reference to the accompanying drawing figures, which show various embodiments by way of illustration. While the embodiments are described in sufficient detail to enable those skilled in the art to practice the invention, it should be understood that other embodiments may be realized, and that logical and mechanical changes may be made without departing from the spirit and scope of the present invention. Thus, the detailed description herein is presented for purposes of illustration only and not of limitation. For example, steps or functions recited in descriptions of any method, system, or process may be executed in any order and are not limited to the order presented. Moreover, any of the step or functions thereof may be outsourced to or performed by one or more third parties. Furthermore, any reference to singular includes plural embodiments, and any reference to more than one component may include a singular embodiment.

In general, the present disclosure relates to methods and systems for recovering metal values from metal-bearing materials and, more specifically, to leaching methods and systems using citric acid or salts thereof and supplementary additions of pyrite to leach a sulfide ore. Various embodiments of the present invention provide a method for recovering a metal value from a metal-bearing material

Various embodiments of the present invention provide a method for recovering copper from a metal-bearing material. In various embodiments, the method comprises obtaining the metal-bearing material from a mine, combining the metal-bearing material with pyrite to form a combined metal-bearing material, heap leaching the combined metal-bearing material with a leaching solution comprising citric acid, with pyrite generating acid, heat, and iron that facilitate recovering copper from the metal-bearing material, and with citric acid both controlling the resulting iron ions and improving wettability of the metal bearing material, and recovering copper from the pregnant leach solution.

Examples of metal values include, but are not limited to, copper, nickel, zinc, silver, gold, germanium, lead, arsenic, antimony, chromium, molybdenum, rhenium, tungsten, iron, ruthenium, osmium, cobalt, rhodium, iridium, palladium, platinum, uranium, or rare earth metals. More preferably, the metal values can be copper, nickel, and/or zinc. Most preferably, the metal value is copper.

Disclosed herein are methods and systems that are designed and configured to improve the recovery of a metal value from a metal-bearing material in leaching systems, utilizing the balancing and manipulation of chemical reactions and solution chemistry to control the chemical characteristics of a leaching system and enable effective leaching conditions. In various embodiments, the leaching system may be a heap leaching system.

In various embodiments, the metal-bearing material may be an ore, a concentrate, a process residue, or any other material from which metal values may be recovered. Metal values, such as those described herein, may be recovered from the metal-bearing material. In an aspect of the present invention, the metal-bearing material may comprise a refractory metal sulfide.

In accordance with various embodiments, the metal-bearing material may comprise chalcocite, pyrite, chalcopyrite, arsenopyrite, bornite, covellite, digenite, cobaltite, enargite, galena, greenockite, millerite, molybdenite, orpiment, pentlandite, pyrrhotite, sphalerite, stibnite, and/or any other suitable metal-bearing ore material. Preferably, the metal-bearing material may comprise primary or secondary sulfides such as chalcocite, bornite, pyrite, or chalcopyrite, or a blend of such mineral species. Various aspects and embodiments of the present invention, however, prove particularly advantageous in connection with the recovery of copper from copper sulfide ores such as, for example, chalcopyrite (CuFeS2), chalcocite (Cu2S), bornite (Cu5FeS4), covellite (CuS), enargite (Cu3AsS4), digenite (Cu9S5) and mixtures thereof. Thus, the metal-bearing material may be a copper ore or concentrate, and preferably, is a copper sulfide ore or concentrate. Most preferably, the metal-bearing material is chalcopyrite.

In an aspect of the present invention, all or a portion of the metal-bearing material may be further processed via size classification and/or crushing to achieve a desired particle size distribution, such that, substantially all of the particles are of a size to allow effective agglomeration, if desired, of the metal-bearing material and allow for optimal economic recovery of the contained metal value.

In accordance with various embodiments of the present invention, the metal-bearing material has a particle distribution of any combination of particle distributions. The particle distribution may have a combination of fine and coarse particles. Any particle distribution that maximizes agglomeration and/or curing, and metal recovery is useful. The conditions and parameters of the metal leaching method disclosed herein may be adjusted to achieve an optimized result for leaching and metal recovery.

In accordance with various embodiments, the metal-bearing material may be subjected to agglomeration process to produce an agglomerated metal-bearing material. In various embodiments, the agglomeration process may include combining the metal-bearing material with an agglomeration solution. In various embodiments, the agglomeration solution may comprise a raffinate. In various embodiments, a raffinate provided from any other metal recovery process (not shown) may be used to form the agglomerated metal-bearing material. In various embodiments, the raffinate may be an aqueous product of a solvent extraction process, such as, for example, a conventional solvent extraction/electrowinning (SX/EW) process, or a direct electrowinning (DEW) process. In various embodiments, the raffinate may comprise water and an acid, such as, for example, sulfuric acid.

In various embodiments, pyrite contained within or added to the metal-bearing material may be oxidized during agglomeration. In various embodiments, the oxidation of pyrite may generate heat, sulfuric acid, and ferrous iron, wherein the oxidation of pyrite is a chemical process induced by the interaction of pyrite with oxygen or ferric iron. In various embodiments, due in part to the refractory nature and/or often high concentrations of iron, the reaction generates significant amounts of ferrous iron in solution, which often oxidizes to ferric iron and thus eventually precipitates as iron hydroxide, such as, for example, jarosite. This iron hydroxide precipitation coats the mineral surfaces, preventing further leaching from occurring. Thus, the current inventors have found that the use of pyrite alone generally inhibits metal recovery rather than improves metal recovery from the metal-bearing material. While not wanting to be bound to any particular theory, tests have shown the precipitation of iron from the oxidation process of pyrite is likely a thermodynamically favored reaction that will inevitably produce substantial amounts of iron hydroxide, if not otherwise controlled. Accordingly, use of pyrite, in general, necessitates controlling iron in the reaction solution to enable effective leaching, contrary to prior teachings.

As such, the agglomeration solution may further comprise a chelating agent. In various embodiments, the chelating agent may include citric acid or salts thereof. In various embodiments, citric acid and salts thereof may comprise any amorphous or crystalline form of citric acid, including any hydrate and any mono-, di-, or tri-citrate salt, wherein the counterion of a citrate anion comprises any alkali metal, any alkaline earth metal, or any transition metal cation. Di- and tri-citrate salts of citric acid need not have a single species of cation, and thus citrate salts include di- and tri-salts with any combination of counter-cations. Non-limiting examples of citric acid and salts thereof include citric acid monohydrate, disodium citrate, trisodium citrate, ferric citrate (iron (III) citrate), and tricalcium citrate (commonly referred to as simply “calcium citrate”). Since metal leaching conditions in accordance with the present disclosure are typically acidic, it often does not matter what citrate salt is added to a leach heap since all citrate salts will be converted to citric acid in the acidic leaching conditions.

In various embodiments, citric acid may help keep iron ions in solution, preventing them from precipitating out and keeping them chemically available for use in further reactions. In various embodiments, citric acid finds particular use controlling iron ions, preventing iron hydroxide precipitation and ultimately passivation. In various embodiments, citric acid may control iron ions in multiple ways.

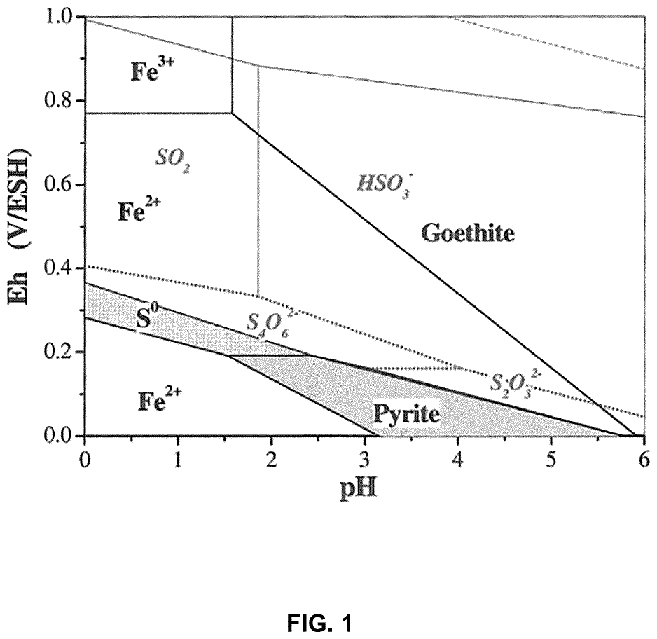

Typically, iron ions will precipitate out of solution at a pH of around 4, as illustrated by the Pourbaix Diagram for iron at ambient temperatures shown in FIG. 1. However, it has been found that with citric in solution, the iron ions may have increased stability and remain in solution until the pH of the solution is at about around 5. This increase in iron soluble pH range allows for the solution to have more room for natural variability, allowing operators more flexibility for the control of a leaching system and minimizing the amount of iron hydroxide formed. The impact of citric in keeping iron ions in solution is immediately apparent, even upon visual inspection of solutions. In various experiments, it was seen that solutions without citric acid comprising a pH of 4 were significantly opaquer (i.e. cloudier) than their citric acid containing counterparts. This demonstrated that less iron precipitated out into solution in the citric containing samples at the same pH.

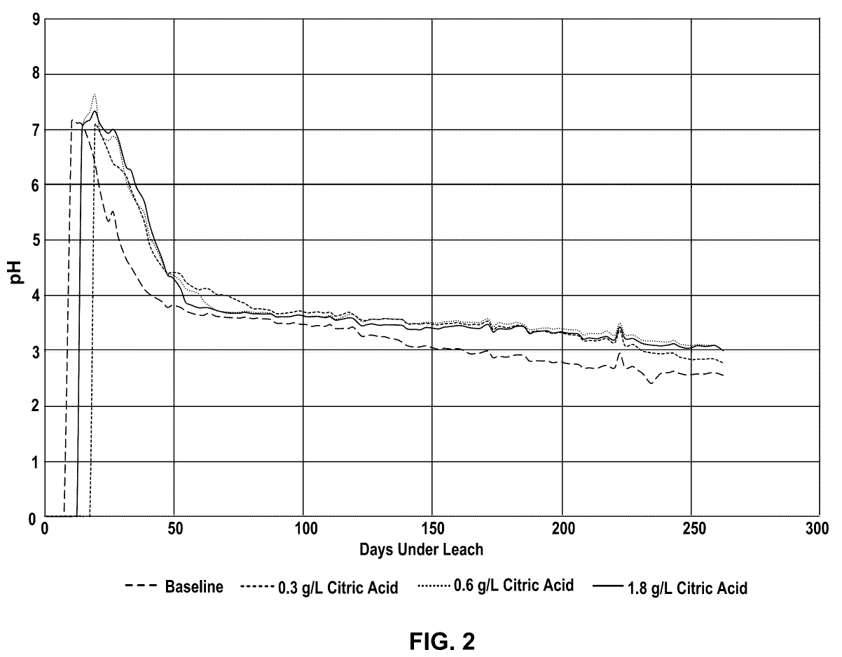

This concept is demonstrated in FIG. 2. In FIG. 2, three concentrations of citric acid were tested along with a baseline trial containing no citric acid. In each of the three trials containing citric acid, the pH of solution is higher than that the baseline trial. Despite operating within the typical Eh/pH at which iron hydroxides are produced (see FIG. 1), none is seen within the columns, indicating that citric acid is able to keep iron in solution at a higher pH than is typical. In various embodiments, while not being tied to one theory, citric acid may convert ferric iron into ferrous iron, preventing iron hydroxide precipitation. However, citric acid may keep iron in solution at higher pH's by other mechanisms.

Thus, the use of citric acid in chalcopyrite leaching renders pyrite oxidation a feasible option for enhancing leaching operations. Additionally, while performing extensive testing of citric acid to identify various operational mechanisms through which citric acid performs, it was surprisingly found that the citric acid lowers the contact angle of a leaching solution on chalcopyrite, improving wettability. Thus, the leaching solution can more effectively penetrate the surface of the ore, resulting in a higher extraction of metal and improved recoveries. Prior research into citric acid, such as Haas, merely noted that improved permeability was seen in ores contacted with citric acid and did not teach or suggest the use of citric acid to directly increase recovery rates. Additionally, citric acid surprisingly finds use as a surfactant, thereby contributing to copper recovery through several unique mechanisms.

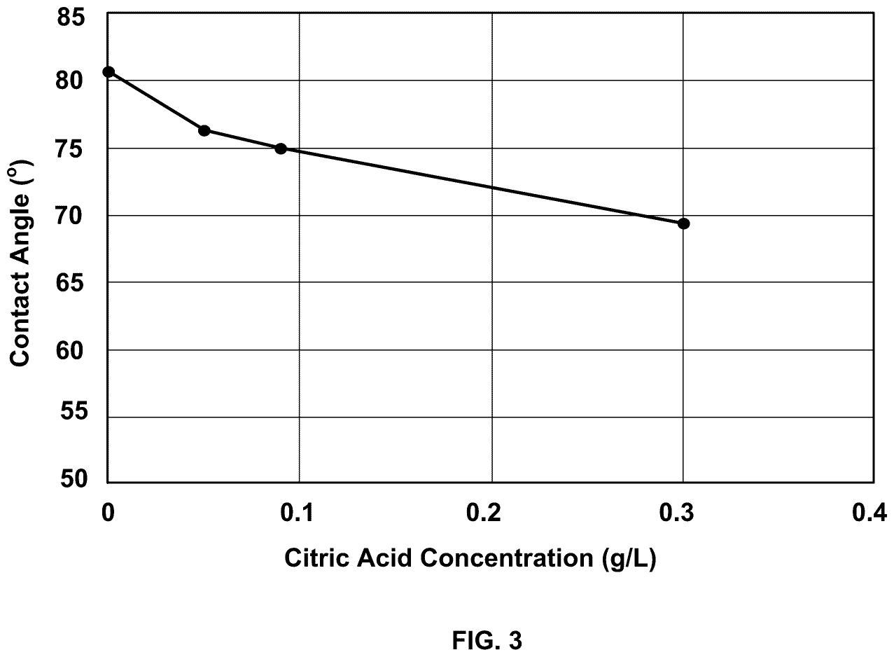

This concept is demonstrated in FIG. 3. In FIG. 3, three concentrations of citric acid were tested along with a baseline trial containing no citric acid. As the concentration of citric acid increased, the contact angle of the chalcopyrite ore sample decreased. Thus, the chalcopyrite samples had increased wettability and were able to more effectively interact with the leaching solution, increasing metal recovery. However, the ability of citric acid to lower contact angle, i.e. operate as a surfactant, is more effective at lower concentrations, such as, for example, lower than about 0.5 g/L.

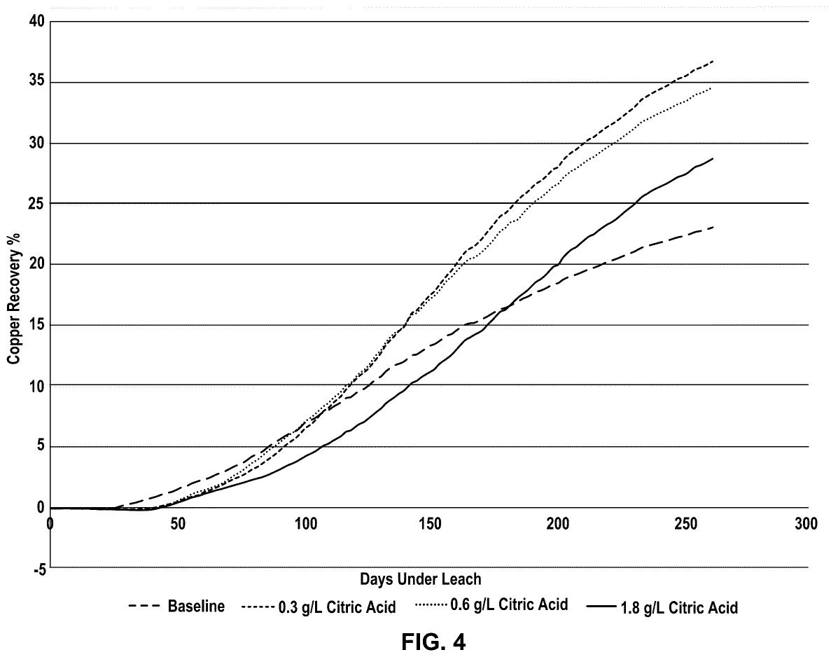

As can be seen in FIG. 4, the use of citric acid in leaching solutions improves copper recovery. This improvement is particularly evident at lower concentrations of citric acid. While not being bound by any particular theory, it may be that as citric acid concentration increases past surfactant effective doses, the contact angle is not sufficiently decreased to improve wettability of the ore, resulting in lower metal recovery. To state it another way, low concentrations of citric acid lower the contact angle of chalcopyrite ores, resulting in increased wettability and improved copper recovery. However, as citric acid concentrations increase beyond surfactant effective doses, contact angle is not sufficiently decreased to meaningfully contribute to copper recovery. Thus, while citric acid improves metal recovery across a wide range of concentrations, such as by its chelating and/or iron ion control characteristics, it finds particular use as a surfactant at lower concentrations.

In various embodiments, the pyrite source may be naturally occurring within the metal-bearing material. In other embodiments, additional pyrite may be added to agglomeration, wherein the pyrite source comes from other mining processes, such as, for example, pyrite rich tailings and/or ore stockpiles.

In various embodiments, exposing the citric acid enhanced solution to ultraviolet (UV) light may have a synergistic effect on lowering the ORP of solutions to improve chalcopyrite leaching. In various embodiments the source of UV light may come from exposing the solution to the sun or any light source suitable for the production of UV rays.

In various embodiments, the agglomeration process may comprise resting the metal-bearing material in the agglomeration solution for a certain period of time. In various embodiments, the certain period of time may be adjusted to achieve an optimized result for agglomeration and metal recovery. In various embodiments, the metal-bearing material may rest in the agglomeration solution for any duration in the range of about 0 to about 8 days. In various embodiments, the metal-bearing material may rest in the agglomeration solution for any duration in the range of about 0 to about 4 days. In various embodiments, the metal-bearing material may rest in the agglomeration solution for any duration on the order of at least 1 day.

The quantity of the raffinate, citric acid, and oxidant in the agglomeration solution may vary with respect to the type and/or quantity of metal-bearing material used. In various embodiments, the agglomeration solution may include a certain concentration of citric acid. In various embodiments, the concentration of citric acid in the agglomeration solution may be adjusted to achieve an optimized result for agglomeration and metal recovery. In various embodiments, the agglomeration solution may comprise a concentration of citric acid in the range of about less than about 5 g/L, preferably on the order of about 0.1 to about 3 g/L, more preferably on the order of about 0.3 g/L to about 0.6 g/L to about 1.8 g/L, and even more preferably on the order of about 0.3 g/L.

In various embodiments, the agglomeration solution may also include a certain concentration of pyrite. In various embodiments, the concentration of citric acid in the agglomeration solution may be adjusted to achieve an optimized result for agglomeration and metal recovery. In various embodiments, the concentration of pyrite may be that which is inherently in the metal-bearing material. In various other embodiments a supplementary addition of pyrite to the metal-bearing material may be included.

In various embodiments, the method further comprises a leaching process. In various embodiments the metal-bearing material may skip the agglomeration process completely and move straight to the leaching process. In various embodiments, the leaching process may comprise combining the metal-bearing material (or agglomerated metal-bearing material in embodiments comprising an agglomeration process) with a leaching solution to form a pregnant leach solution. In various embodiments, the leaching solution comprises the raffinate and any additional additives as described above as needed to improve metal recovery, such as, for example, citric acid. In various embodiments, supplementary additions of pyrite may be added to the metal-bearing material before it is combined with the leaching solution.

In various embodiments, the leaching process may comprise heap leaching. In various embodiments, heap leaching may comprise stacking or forming the metal-bearing material or agglomerated metal-bearing material into a heap or a portion of a heap. In various embodiments, heap leaching may comprise leaching the heap with the leaching solution after the heap is formed. In another aspect of the invention, the leaching process may comprise any other known leaching method, such as a column or shake flask leaching. In various embodiments, the leaching further comprises an injection of oxygen or air into the heap.

As discussed above, a widespread issue with leaching sulfide ores is the tendency for iron hydroxides to precipitate. This not only results in passivation of the ore, inhibiting the leaching solution from reaching the mineral surface, but also, when applied to heap leaching, creates permeability issues within the heap as the precipitates plug up flow paths within the heap. Another benefit the disclosed methods and systems is that by keeping iron ions in solution and dissolving precipitated iron back into solution, the permeability and leaching potential of the heap are restored.

In various embodiments, after leaching process, the pregnant leach solution is subjected to a metal recovery process to produce the metal value and the raffinate. In various embodiments, the metal recovery process may comprise a direct electrowinning (DEW) process. In another exemplary embodiment, the metal recovery process may comprise a solvent extraction and electrowinning (SX/EW) process.

In various embodiments, the raffinate may be recirculated and reused in the method. In various embodiments, the raffinate may be reused in the agglomeration process as a component of the agglomeration solution. In various embodiments, the raffinate may be reused in the leaching process as a component of the leaching solution.

In an aspect of the invention, part or all of the metal leaching method may be carried out under a certain pressure and temperature. In various embodiments, the agglomeration process, the leaching process, and the metal recovery process may be carried out under a certain pressure and temperature. In various embodiments, the pressure and/or temperature may be adjusted to achieve an optimized result for agglomeration, leaching and/or metal recovery.

In various embodiments, the agglomeration process, the leaching process, and/or the metal recovery process may be carried out under atmospheric pressure. In various embodiments, the agglomeration process, the leaching process, and/or the metal recovery process may be carried out under another pressure that differs from atmospheric pressure. In various embodiments, the agglomeration process, the leaching process, and/or the metal recovery process may be carried out under an ambient temperature, such as 20-22° C. In various embodiments, the agglomeration process, the leaching process, and/or the metal recovery process may be carried out under another temperature, such as 0-60° C.

In various embodiments, the method may comprise an additional iron precipitation and removal step, wherein iron hydroxides are allowed, and encouraged, to form. After a certain condition is reached, such as, for example, time elapsed or amount of iron hydroxide precipitated, a removal process is completed to render the metal-bearing material amendable for further leaching.

The Examples set forth herein are illustrative of exemplary embodiments of the present invention. The process, conditions and parameters reflected therein are intended to exemplify various aspects of the invention and are not intended to limit the scope of the claimed invention.

### Example 1

A specimen of copper-containing ore was subject to a leaching method disclosed in the present invention. The specimen contained 75% chalcopyrite. A series of trials was run on the ore, with each trail comprising 25 grams of 140 mesh ore added to 15 mL of leaching solution in a 250 mL Erlenmeyer shake flask. The leaching solution contained a raffinate produced from a copper leaching process and various concentrations of hydrogen peroxide (H₂O₂) as detailed in Table 1. Various concentrations of supplementary pyrite additions were combined with the copper-containing ore as detailed in Table 1. After the ore rested in the leaching solution for 24 hours, an additional 125 mL of leaching solution is added to the shake flask. The ore rested an additional 24 hours in the leaching solution before the pregnant leach solution was filtered out and assayed to determine copper recovery. The concentration of additives for each trial are detailed in Table 1.

The following 12 trials of leaching operations were carried out, as listed in Table 1. Except those conditions and reagents listed in Table 1, the 12 trials of leaching operations were carried out under the same conditions with the same reagents, as described above. The variations in hydrogen peroxide and supplementary pyrite additions were used to demonstrate the detrimental effect of pyrite oxidation on copper recovery.

TABLE 1
Impacts of Pyrite on Copper Leaching

| Trial | H₂O₂ Concentration | Pyrite Concentration | Cu Recovery |
|---|---|---|---|
| No. | (wt %) | (wt %) | (%) |
| 1 | 0 | 0 | 19.46 |
| 2 | 0 | 1 | 19.00 |
| 3 | 0 | 3 | 18.10 |
| 4 | 0 | 5 | 17.75 |
| 5 | 5 | 0 | 28.64 |
| 6 | 5 | 1 | 23.03 |
| 7 | 5 | 3 | 21.16 |
| 8 | 5 | 5 | 21.10 |
| 9 | 15 | 0 | 40.11 |
| 10 | 15 | 1 | 39.16 |
| 11 | 15 | 3 | 33.48 |
| 12 | 15 | 5 | 27.85 |

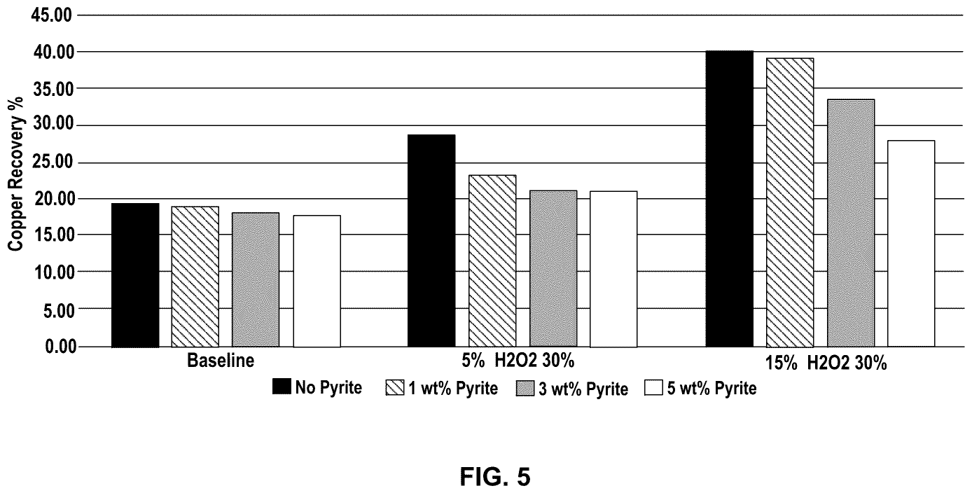

As shown in Table 1, as more pyrite was added, the ultimate copper recovery decreased, with the best performing trial in each group containing no pyrite at all. This demonstrates that when oxidized, either naturally or through the use of oxidants such as, for example, hydrogen peroxide, pyrite fails to improve recovery rates. As there was a fairly significant decrease in recovery in the trials comprising higher amounts of pyrite, it is concluded that the greater the concentration, and therefore oxidation, of pyrite is within a column, the more iron is precipitated out of solution, passivating the ore and inhibiting recovery. A graphical demonstration of Table 1 can be seen in FIG. 5.

### Example 2

A specimen of copper-containing ore was subject to a leaching method disclosed in the present invention. The specimen contained 75% chalcopyrite. A series of trials was run on the ore, with each trail comprising 25 grams of 140 mesh ore added to 15 mL of leaching solution in a 250 mL Erlenmeyer shake flask. The leaching solution contained a raffinate produced from a copper leaching process. Various concentrations of supplementary pyrite additions were combined with the copper-containing ore as detailed in Table 2. After the ore rested in the leaching solution for 24 hours, an additional 125 mL of leaching solution and various concentrations of citric acid as detailed in Table 2 were added to the shake flask. The ore rested an additional 24 hours in the leaching solution before the pregnant leach solution was filtered out and assayed to determine copper recovery. The concentration of additives for each trial are detailed in Table 2.

The following 12 trials of leaching operations were carried out, as listed in Table 2. Except those conditions and reagents listed in Table 2, the 12 trials of leaching operations were carried out under the same conditions with the same reagents, as described above. The variations in citric acid and supplementary pyrite additions were used to demonstrate the effect of citric acid on iron precipitation and ultimate recovery.

TABLE 2
Impacts of Citric Acid on Leaching with Pyrite

| Trial | Citric Acid Concentration | Pyrite Concentration | Cu Recovery |
|---|---|---|---|
| No. | (g/L) | (wt %) | (%) |
| 1 | 0 | 0 | 19.46 |
| 2 | 0 | 1 | 19.00 |
| 3 | 0 | 3 | 18.10 |
| 4 | 0 | 5 | 17.75 |
| 5 | 1 | 0 | 16.38 |
| 6 | 1 | 1 | 20.10 |
| 7 | 1 | 3 | 22.47 |
| 8 | 1 | 5 | 20.22 |
| 9 | 5 | 0 | 17.43 |
| 10 | 5 | 1 | 18.54 |
| 11 | 5 | 3 | 21.11 |
| 12 | 5 | 5 | 18.24 |

As shown in Table 2, the ore leached with a combination of pyrite and citric acid improved as more pyrite was added, while the ore leached with only pyrite decreased in recovery as more pyrite was added. This demonstrates that citric acid is beneficial in controlling the amount of iron in solution and preventing recovery inhibition.

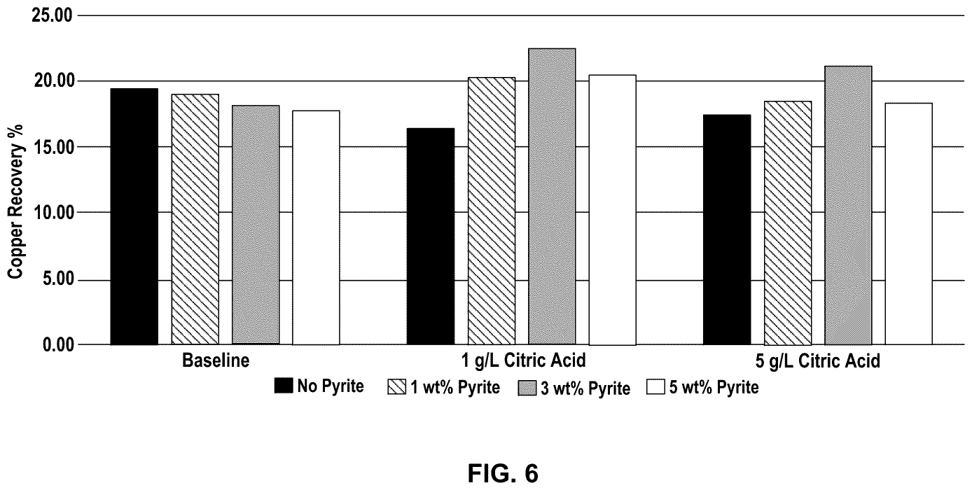

However, as also can be seen in trials 8 and 12 in Table 2 citric acid can only control generated iron up to a certain degree, and if too much pyrite is added, recovery will begin diminishing regardless of citric acid. Therefore, supplementary pyrite additions should be controlled, as too high of a concentration will overwhelm the chemical balance. A graphical demonstration of Table 2 can be seen in FIG. 6.

### Example 3

Two copper containing solutions were subjected to experimental conditions designed to demonstrate the effect of UV light on citric acid's ability to lower ORP of leaching solutions to improve chalcopyrite leaching and copper recovery. Solution 1 comprised raffinate from a mining operation that comprises about 0.07 g/L copper, 4 g/L free acid, and 2.5 g/L total iron, with ferric iron comprising all of the iron. Solution 2 comprised raffinate from a mining operation that comprises about 0.04 g/L copper, 2 g/L free acid, and 10 g/L total iron, with ferrous iron comprising 3 g/L. Both Solution 1 and 2 comprised 3 g/L of citric acid. As detailed in Table 3 below, 2 trials were run on each Solution (for a total of 4 trials), with 1 trial for each Solution exposed to UV light. The initial pH and ORP of each trial were taken initially and after 1 hour. The results are shown in Table 3 and, except those conditions listed in Table 3, the 4 trials were carried out under the same conditions, as described above.

TABLE 3
Synergy of UV Light and Citric
Acid on Solution pH and ORP

| | | UV | Initial | | 1 Hour | |
|---|---|---|---|---|---|---|
| Trial | Solution | Exposure | pH | ORP | pH | ORP |
| 1 | 1 | No | 1.51 | 667 | 1.48 | 623 |
| 2 | 1 | Yes | 1.51 | 667 | 1.45 | 481 |
| 3 | 2 | No | 1.75 | 686 | 1.71 | 653 |
| 4 | 2 | Yes | 1.75 | 686 | 1.69 | 529 |

As shown in Table 3, solutions comprising citric acid that are exposed to UV light are more effective at controlling solution ORP. However, even those solutions not exposed to UV light resulted in lower ORPs, demonstrating that the citric acid lowers ORP of solutions even without UV exposure, albeit slower. As further shown in Table 3, the use of UV exposure compared to no UV exposure has no significant impact on pH, ensuring that other leaching conditions will not be impacted.

### Example 4

An inactive leach stockpile at a mining operation was subject to experimental conditions designed to determine if citric acid can improve permeability on a stockpile that has experienced surface passivation from iron precipitation. The stockpile was subjected to a treatment solution comprising raffinate and 3 g/L citric acid, with the solution dispersed to the heap through a combination of surface driplines and six deep raffinate wells spread across the experimental area of the stockpile.

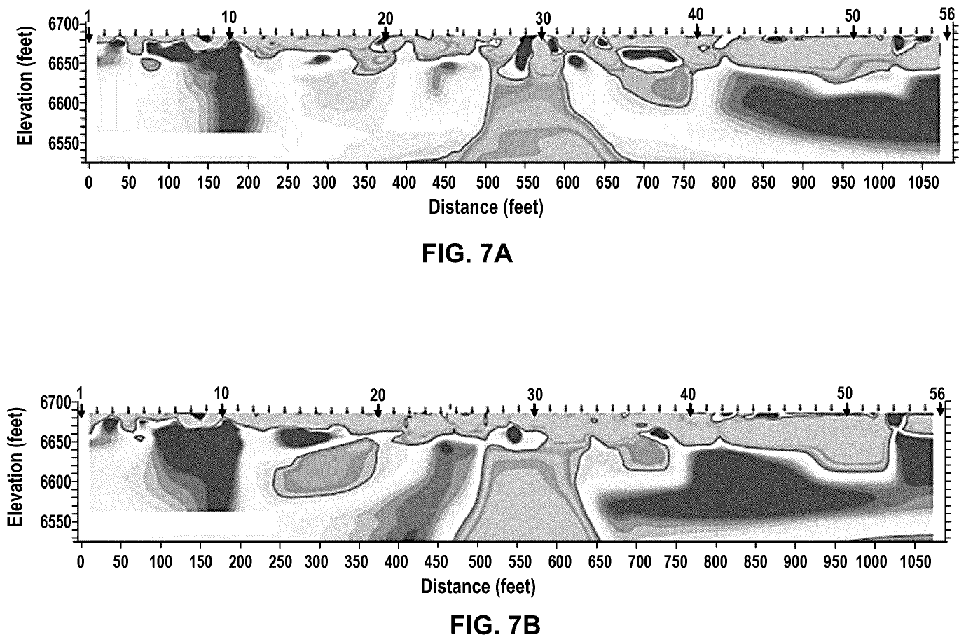

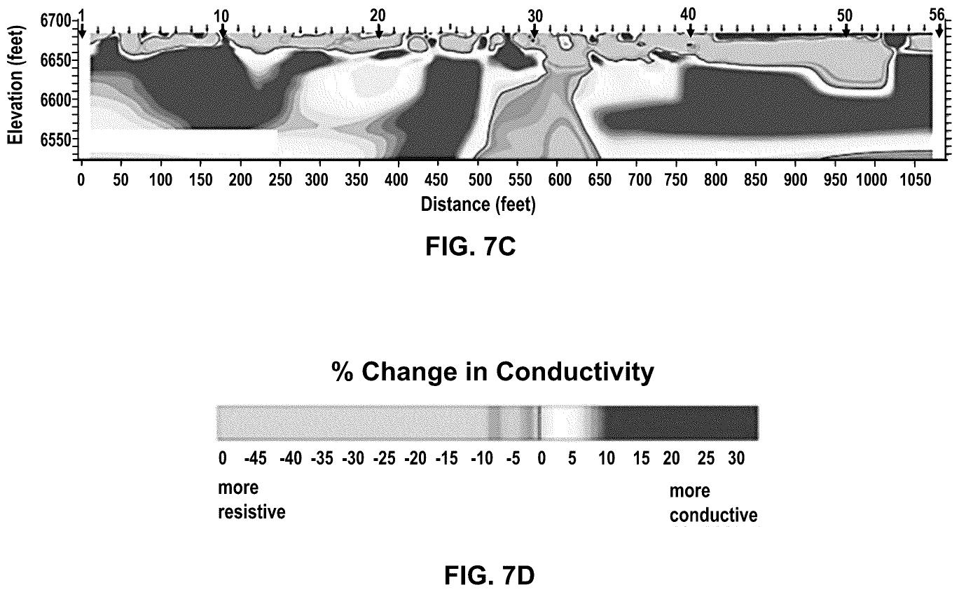

After the stockpile was treated with the treatment solution for 90 days, a resistivity scan was taken of the stockpile and compared it to a resistivity scan taken before and during treatment (see FIGS. 7A-7C). Resistivity is an indicator of stockpile permeability, where the more resistive (i.e. less conductive) a material is, the less permeable it is. The scan taken after the treatment showed reduced resistivity and thus increase permeability across the stockpile. Further, visual inspection of the surface of the stockpile before and after treatment showed significantly less ponding of solution, allowing for the conclusion that increased solution dispersed down into the stockpile.

Therefore, citric acid may be used to treat a passivated stockpile, as it dissolves precipitated iron into solution, freeing up areas previously plugged with the iron and improving permeability of the stockpile. This renders the stockpile amenable for further leaching, and ultimately increases the amount of metal value recovered from the stockpile.

Additionally, citric acid may allow iron to stay in solution at higher pH's, granting operators more leeway in operational conditions. The iron control effect of citric acid thus renders the use of pyrite oxidation feasible to enhance leaching conditions through the production of heat and acid.

While the above example used a resistivity scan to identify passivation of the leach stockpile, any known permeability test could be used, such as, for example, soil permeability testing devices (e.g. a permeameter), electric cone penetration testing, hydraulic scanners, and/or flow sensors, to name a few.

According to various embodiments, the disclosed invention further enables a leaching operation to recover a substantial amount of copper from refractory ores through the use of citric acid to control iron ions during the leaching process. Additionally, citric acid finds surprising use as a surfactant, decreasing contact angle and improving wettability of the ore.

As discussed above, the present invention includes a metal leaching method utilizing citric acid and pyrite, to improve the efficiency of metal extraction operations. The present invention has been described with reference to various exemplary embodiments. However, many changes, combinations, and modifications may be made to the exemplary embodiments without departing from the scope of the present invention. For example, the various components may be implemented in alternate ways. These alternatives can be suitably selected depending upon the particular application or in consideration of any number of factors associated with the operation of the system. In addition, the techniques described herein may be extended or modified for use with other metal extraction processes. These and other changes or modifications are intended to be included within the scope of the present claims.

The present invention has been described above with reference to a number of exemplary embodiments. It should be appreciated that the particular embodiments shown and described herein are illustrative of the invention and its best mode and are not intended to limit in any way the scope of the invention as set forth in the claims. Those skilled in the art having read this disclosure will recognize that changes and modifications may be made to the exemplary embodiments without departing from the scope of the present invention. For example, various aspects and embodiments of this invention may be applied to recovery of metals other than copper, such as nickel, zinc, cobalt, and others. Although certain preferred aspects of the invention are described herein in terms of exemplary embodiments, such aspects of the invention may be achieved through any number of suitable means now known or hereafter devised. Accordingly, these and other changes or modifications are intended to be included within the scope of the present invention.

It is believed that the disclosure set forth above encompasses at least one distinct invention with independent utility. While the invention has been disclosed in the exemplary forms, the specific embodiments thereof as disclosed and illustrated herein are not to be considered in a limiting sense as numerous variations are possible. Equivalent changes, modifications and variations of various embodiments, materials, compositions and methods may be made within the scope of the present invention, with substantially similar results. The subject matter of the inventions includes all novel and non-obvious combinations and sub combinations of the various elements, features, functions and/or properties disclosed herein.

Benefits, other advantages, and solutions to problems have been described herein with regard to specific embodiments. However, the benefits, advantages, solutions to problems, and any element or combination of elements that may cause any benefit, advantage, or solution to occur or become more pronounced are not to be construed as critical, required, or essential features or elements of any or all the claims or the invention. Many changes and modifications within the scope of the instant invention may be made without departing from the spirit thereof, and the invention includes all such modifications. Corresponding structures, materials, acts, and equivalents of all elements in the claims below are intended to include any structure, material, or acts for performing the functions in combination with other claim elements as specifically claimed. The scope of the invention should be determined by the appended claims and their legal equivalents, rather than by the examples given above.

What is claimed is:

1. A method for recovering a metal value from a metal-bearing material, comprising:
exposing a leaching solution to a source of UV light;
applying the leaching solution to the metal-bearing material to form a pregnant leach solution, wherein the leaching solution comprises a raffinate and a chelating surfactant, wherein the chelating surfactant is comprised of citric acid or salts thereof and decreases a contact angle between the leaching solution and the metal-bearing material by between about 6 degrees to about 12 degrees; and
recovering the metal value from the pregnant leach solution to form the raffinate;
wherein the metal-bearing material comprises pyrite, wherein the leaching solution comprises a concentration of citric acid in a range of about 0.1 g/L to about 0.3 g/L, wherein the exposing the leaching solution to the source of UV light has a synergistic effect with citric acid or salts thereof of lowering an oxidation-reduction potential of the leaching solution, [and] wherein the raffinate comprises a retained concentration of citric acid or salts thereof greater than 0 g/L, and wherein the method enhances copper recovery by at least about 15% during a leaching cycle.

2. The method of claim 1, further comprising:
precipitating, via a precipitation process, iron hydroxide out of the metal-bearing material; and
removing, via a removal process, the iron hydroxide from the metal-bearing material, wherein the removing renders the metal-bearing material amenable to an additional leaching process.

3. The method of claim 1, further comprising adding a supplementary addition of pyrite to the metal-bearing material.

4. The method of claim 1, further comprising agglomerating the metal-bearing material with an agglomeration solution before the step of applying the leaching solution, wherein the agglomeration solution comprises the raffinate and optionally citric acid or salts thereof.

5. (canceled)

6. (canceled)

7. (canceled)

8. The method of claim 1, wherein the source of UV light comprises at least one of artificial light or the Sun.

9. The method of claim 1, further comprising forming at least a portion of a heap with the metal-bearing material before the step of applying the leaching solution to the metal-bearing material.

10. The method of claim 1, wherein the raffinate is recycled in the method.

11. A method of recovering copper from a metal-bearing material, comprising:
obtaining the metal-bearing material from a mine;
combining the metal-bearing material with pyrite to form a combined metal-bearing material;
heap leaching the combined metal-bearing material with a leaching solution comprising a chelating surfactant, wherein the chelating surfactant is comprised of citric acid or salts thereof, with pyrite generating acid, heat, and iron that facilitate recovering copper from the metalbearing material, and with the chelating surfactant converting ferric iron into ferrous iron to prevent iron hydroxide precipitation, and forming a pregnant leach solution; and
recovering copper from the pregnant leach solution.

12. The method of claim 11, wherein the leaching solution comprises a concentration of citric acid or salts thereof in the range on the order of about 0.1 g/L to about 3 g/L.

13. The method of claim 11, wherein the metal-bearing material comprises an inherent concentration of pyrite.

14. The method of claim 11, wherein the metal-bearing material is chalcopyrite.

15. A method of treating a leaching stockpile, the method comprising:
identifying, via a permeability test, at least one area of passivated metal-bearing material within the leaching stockpile;
treating the at least one area of passivated metal-bearing material with a treatment solution comprising citric acid or salts thereof, wherein the treatment solution dissolves a precipitated material into the treatment solution to form a pregnant leach solution; and
recovering a metal value from the pregnant leach solution.

16. The method of claim 15, wherein the precipitated material is an iron hydroxide.

17. The method of claim 15, wherein the treatment solution comprises a concentration of citric acid or salts thereof in the range on the order of about 0.1 g/L to about 3 g/L.

18. The method of claim 15, wherein the treatment solution comprises a concentration of citric acid or salts thereof in the range on the order of more than 0 g/L but less than about 5 g/L.

19. The method of claim 15, wherein the metal-bearing material comprises pyrite.

20. The method of claim 15, wherein the metal value is copper.
